(19) United States
(12) Patent Application Publication
(10) Pub. No.: US 2008/0263242 A1
(43) Pub. Date: Oct. 23, 2008

(54) USB FLASH MEDIA EXTENDER

(76) Inventors: Adrian Bica, Twinsburg, OH (US); Justin T. Gierke, Lakewood, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/736,637

(22) Filed: Apr. 18, 2007

(51) Int. Cl. G06F 13/38; G06F 12/00

(52) U.S. Cl. 710/62; 711/103

(57) ABSTRACT

A system and method for extending communications between a USB host and a flash media device. The system is capable of converting command block wrapper data to SCSI data and sending the converted data over a non-USB communications channel, such as a Category 5 cable. The system is further capable of receiving the data sent over the non-USB communications channel and converted the received data back to command block wrapper data prior to sending the data to a flash media device.

### FIELD OF THE INVENTION

The present invention relates to extending communications between a USB host and a flash media device, and more specifically to a system and method for extending data over a non-USB communications channel, such as a Category 5 (CAT5) cable.

### BACKGROUND OF THE INVENTION

Universal Serial Bus (“USB”) is a peripheral bus standard developed by the PC and telecom industries, including Compaq, DBC, IBM, Intel, Microsoft, NEC and Northern Telecom. USB defines a bus and protocols for the connection of computer peripherals to computers (and computers to each other). “Universal Serial Bus Specification,” Compaq, Intel, Microsoft, NEC, Revision 1.1, Sep. 23, 1998, describes USB and its implementation and is incorporated herein by reference. Proposed and actual USB devices include keyboards, mice, telephones, digital cameras, modems, digital joysticks, CD-ROM drives, tape and floppy drives, digital scanners, printers, MPEG-2 video-base products, data digitizers and other relatively low bandwidth devices. USB version 1.x supports data rates of up to 12 Mb/sec.

In addition to standard USB devices and technologies, a new USB standard 2.x now exists. “Universal Serial Bus Specification,” Compaq, Hewlett-Packard, Intel, Lucent, Microsoft, NEC, Philips, Revision 2.0, Apr. 27, 2000 describes the most current USB 2.x standard and its implementation and is incorporated herein by reference. The USB 2.x standard permits faster data transmission than the USB 1.x standard. For example, USB version 2.x supports data rates of approximately 480 Mb/sec.

USB supports the dynamic insertion and removal of devices from the bus (or “hot-plugging”) and recognizes actual peripherals or functions; hosts (typically a computer); and hubs, which are intermediate nodes in the network that allow the attachment of multiple downstream hubs or functions. Upon insertion of a downstream hub or function, the host/hub on the upstream side of the bus initiates a bus enumeration to identify and configure the new device. Upon removal, the removed device is “forgotten.” Some examples of USB 2.x devices are: digital cameras, CD-ROM burners, DVD drives, flash card readers, scanners, and hard drives.

Flash memory is a type of non-volatile memory that is capable of high speed reading and writing as well as high memory storage density. Due to these desirable characteristics, flash memory is popular in many industries including communications, consumer electronics, data processing and transportation industries. For example, flash media “jump drives” are becoming increasingly popular in consumer electronics. A typical jump drive is equipped with a USB connector and is USB-compliant to facilitate fast data transfer rates. “Universal Serial Bus Mass Storage Class, Bulk-Only Transport, Revision 1.0, Sep. 31, 1999” (“Mass Storage Specification”) which is incorporated by reference herein, describes the standard by which jump drives operate.

Keyboard, video and mouse extenders currently exist to extend the distance between a computer, typically a USB host, and a user station including a keyboard, mouse and monitor. With the increase in popularity of flash media devices, it is desirable to also extend the distance between a USB host and a flash media device.

### BRIEF SUMMARY OF THE INVENTION

Disclosed is a flash media extender that comprises a local unit and a remote unit. The local unit is operably connectable to an external USB host and an external non-USB communications channel and is configured to simulate a hot plug and emulate an external flash media device to the USB host. The remote unit is operably connectable to the external flash media device and the non-USB communications channel, wherein the non-USB communications channel and the local unit are external to the remote unit. The local unit is configured to receive command block wrapper data from the USB host, convert the command block wrapper data to SCSI data, and send the converted data to the remote unit via the non-USB communications channel. The remote unit is configured to enumerate the flash media device and is further configured to receive the converted data sent by the local unit via the non-USB communications channel, convert the received data to command block wrapper data, and send the command block wrapper data to the flash media device.

Also disclosed is a flash media extender that comprises a local unit and a remote unit. The local unit is operably connectable to an external USB host and an external non-USB communications channel. The local unit comprises a local unit controller configured to simulate a hot plug and emulate an external flash media device to the USB host and to control data flow; a USB host transceiver configured to convert command block wrapper data to SCSI data and to convert SCSI data to command block wrapper data; and a non-USB transceiver configured to send the converted data to a remote unit via a non-USB communications channel. The remote unit is separately housed from the local unit and the non-USB communications channel and is operably connectable to the external flash media device and the non-USB communications channel. The remote unit comprises a remote unit controller configured to enumerate the flash media device and to control data flow; a non-USB transceiver configured to receive the converted data sent by the local unit via the non-USB communications channel; and a USB device transceiver configured to convert the received data to command block wrapper data.

Also disclosed is a method for extending communication between a flash media device and a USB host. The method comprises simulating a hot plug and emulating a flash media device to a USB host; receiving at a local unit command block wrapper data; converting the received command block wrapper data to SCSI data; sending the converted data to a remote unit via a non-USB communications channel that is separately housed from the local unit and the remote unit; receiving at the remote unit the converted data via the non-USB communications channel; converting the data received via the non-USB communications channel to command block wrapper data; and sending the command block wrapper data to a flash media device.

It is therefore a general object of the present invention to provide an extender for extending communication between a USB host and a flash media device.

Another object of the present invention is to provide an extender that converts data received from a USB host and from a flash media device to a different form and sends the converted data over a non-USB communications channel.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE SEVERAL VIEWS OF THE DRAWINGS

FIG. 1 is a block diagram of a system including a flash media extender according to the present invention;

FIGS. 2 is flow chart generally illustrating some of the functionality of the local unit;

FIGS. 3 is flow chart generally illustrating some of the functionality of the remote unit; and

FIGS. 4A-B are two parts of the general data flow for a flash media extender such as the flash media extender of FIG. 1.

### DETAILED DESCRIPTION OF THE INVENTION

The present invention relates to a method for extending communication between a flash media device and a USB host. To increase the distance between a USB host and a flash media device, a system including a local unit and a remote unit may be used. The local unit and the remote unit are preferably connected via a non-USB communications channel. In the presently preferred embodiment, the local unit and remote unit are connected via a four pair cable, such as a category 5 (“CAT5”) cable. The local unit is operably connectable to an external USB host and is configured to simulate a hot plug and emulate the flash media device to the USB host. The remote unit is operably connectable to the flash media device and is configured to enumerate the flash media device. The local unit is further configured to receive command block wrapper data from the USB host, convert the command block wrapper data to SCSI data, and send the converted data to the remote unit via the non-USB communications channel. In addition to enumerating the flash media device, the remote unit is configured to receive the converted data sent by the local unit via the non-USB communications channel, convert the received data to command block wrapper data, and send the command block wrapper data to the flash media device.

Generally, the remote unit detects the presence of a flash media device and enumerates the device. The remote unit preferably emulates a USB host to the flash media device. In other words, to the flash media device, the remote unit appears as a USB host. The remote unit gathers information about the flash media device and sends the flash media device information to the local unit. When the local unit is notified by the remote unit that a flash media device is connected to the remote unit, the local unit simulates a hot plug with the USB host. The local unit emulates the flash media device so that when the USB host enumerates the local unit, it will appear to the USB host that the USB host is connected directly to the flash media device. This emulation causes the USB host to load the drivers that are appropriate for the flash media device. Once the USB host loads the appropriate drivers for the flash media device, the USB host begins transmitting data to the local unit.

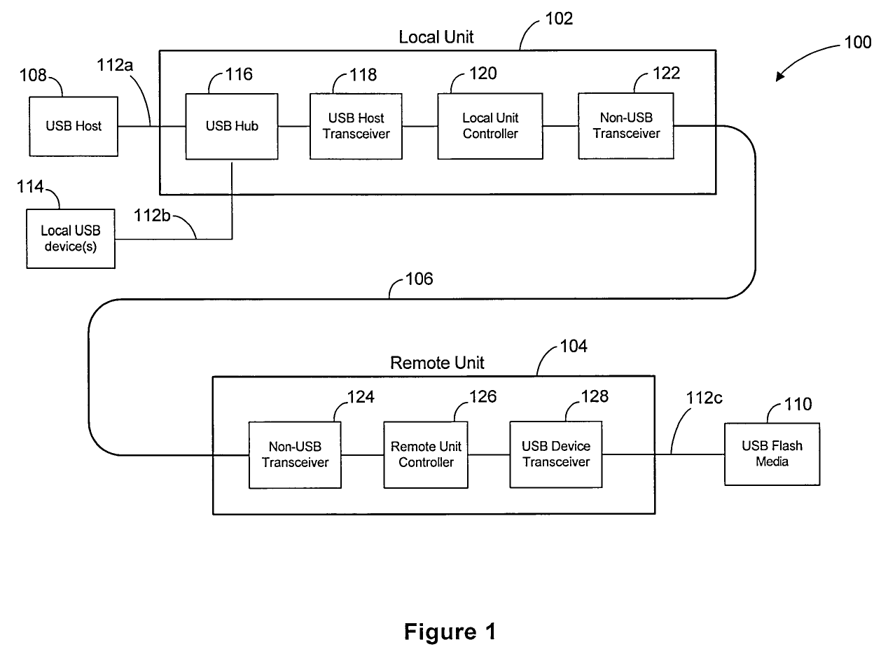

Turning initially to FIG. 1, a diagram of a system with flash media extender is provided. The system includes a local unit 102 and a remote unit 104 connectable via a non-USB communications channel 106. The local unit 102 is connectable to a USB host 108 via a USB communications channel 112a. The local unit 102 may also be connected to local USB device 114 via a USB communications channel 112b. To accommodate the local USB device(s) 114, the local unit 102 may include an optional USB hub 116. The remote unit is connectable to a flash media device 110 via a USB communications channel 112c.

Referring first to the data path from the USB host 108 to the flash media device 110, the USB host begins transmitting data to the local unit 102 in the form of command block wrapper (“CBW”) data. Command block wrapper data is comprised of SCSI-3 data as well as additional information as set forth in the Mass Storage Specification incorporated by reference herein.

The CBW data is received at the USB host transceiver 118 via the USB communication channel 112a and the USB hub 116. The USB host transceiver 118 is configured to transmit the CBW commands received from the USB host 108 to the local unit controller 120. The USB host transceiver 118 may be configured to emulate a mass storage device. In other words, to the USB host 108, the USB host transceiver 118 appears to be a mass storage device, such as the flash media device 110.

The CBW data is then sent from the USB host transceiver 118 to the local unit controller 120. The local unit controller 120 is configured to control data flow between the USB host 108 and the local unit 102. The local unit controller 120 may also be configured to control data flow between the local unit 102 and the remote unit 104. In addition, the local unit controller 120 may be configured to emulate a mass storage device, such as the flash media device 110, to the USB host 108. Also, the local unit controller 120 and the USB host transceiver 118 may be configured to work together to emulate a USB mass storage device. The local unit controller 120 is also preferably responsible for handling all data processing in the local unit 102.

The CBW data is then sent to the non-USB transceiver 122. The non-USB transceiver 122 is preferably configured to convert the CBW data to SCSI data, preferably SCSI-3 data. The non-USB transceiver 122 may further be configured to convert the CBW or SCSI data into a non-SCSI asynchronous serial data stream for transmission over the non-USB communications channel 106. In addition, the non-USB transceiver 122 may also be configured to convert the electric levels of the data stream into appropriate levels for transmission over the non-USB communications channel 106. For example, if the non-USB communications channel is a CAT5 cable, the non-USB transceiver 122 may include an RS485 driver to convert the electric levels to suitable levels for CAT5 cable data transmission.

The converted data is thus sent to the remote unit 104 via the non-USB communications channel 106. At the remote unit 104, the non-USB transceiver 124 is configured to receive the data transmission over the non-USB communications channel 106. The non-USB transceiver 124 is preferably configured to convert the data received from the local unit 102 into CBW data. For example, the non-USB transceiver 124 may be configured to convert a non-SCSI asynchronous serial data stream into SCSI or CBW data.

The CBW data is then sent from the non-USB transceiver 124 to the remote unit controller 126. The remote unit controller 126 is configured to control data flow between the remote unit 104 and the flash media device 110. The remote unit controller 126 may also be configured to control data flow between the local unit 102 and the remote unit 104. In addition, the remote unit controller 126 is preferably configured to emulate a USB host, such as USB host 108, to the flash media device 110. In other words, to the flash media device 110, the remote unit controller 126 appears to be the USB host 108. The remote unit controller 126 is also preferably responsible for handling all data processing in the remote unit 104.

The CBW data is then sent to the USB device transceiver 128. The USB device transceiver 128 is configured to transmit the CBW commands received from the remote unit controller 126 to the flash media device 110 via a USB communications channel, such as USB communications channel 112c. The USB device transceiver 128 may also be configured to emulate a USB host.

In addition to receiving CBW data from the USB host 108 and sending the CBW data to the flash media device 110, the flash media extender 100 is also preferably capable of receiving command status wrapper (“CSW”) data from the flash media extender 100 and sending the CSW data to the USB host 108. Command status wrapper data is comprised of SCSI-3 data as well as additional information as set forth in the Mass Storage Specification incorporated by reference herein.

The CSW data is received at the USB device transceiver 128 via the USB communication channel 112c. The USB device transceiver 128 is configured to transmit the CSW data received from the flash media device 110 to the remote unit controller 126. The USB device transceiver 128 may be configured to emulate the USB host 108. In other words, to the flash media device 110, the USB device transceiver 128 appears to be the USB host 108.

The CSW data is then sent from the USB device transceiver 128 to the remote unit controller 126, which is preferably configured to control the CSW data flow data flow between the flash media device 110 and the remote unit 104. The remote unit controller 126 may also be configured to control CSW data flow between the local unit 102 and the remote unit 104.

The CSW data is then sent to the non-USB transceiver 124. The non-USB transceiver 124 is preferably configured to convert the CSW data to SCSI data, preferably SCSI-3 data. The non-USB transceiver 124 may further be configured to convert the CSW or SCSI data into a non-SCSI asynchronous serial data stream for transmission over the non-USB communications channel 106. In addition, the non-USB transceiver 124 may also be configured to convert the electric levels of the data stream into appropriate levels for transmission over the non-USB communications channel 106. For example, if the non-USB communications channel 106 is a CAT5 cable, the non-USB transceiver 124 may include an RS485 driver to convert the electric levels to suitable levels for CAT5 cable data transmission.

The converted data is thus sent to the local unit 102 via the non-USB communications channel 106. At the local unit 102, the non-USB transceiver 122 is configured to receive the data transmission over the non-USB communications channel 106. The non-USB transceiver 122 is preferably configured to convert the data received from the remote unit 104 into CSW data. For example, the non-USB transceiver 122 may be configured to convert the non-SCSI asynchronous serial data stream into SCSI or CSW data. In addition, the non-USB transceiver 122 may further be configured to convert the electric levels of the data stream into appropriate levels for transmission to the USB host 108.

The CSW data is then sent from the non-USB transceiver 122 to the local unit controller 120. The local unit controller 120 is configured to control CSW data flow between the local unit 102 and the USB host 108. The local unit controller 120 may also be configured to control data flow between the local unit 102 and the remote unit 104.

The CBW data is then sent to the USB host transceiver 118. The USB host transceiver 118 is configured to transmit the CSW commands received from the local unit controller 120 to the USB host 108 via a USB communications channel, such as USB communications channel 112a, and optionally, via a USB hub 116 and USB communications channel 112a.

It will be understood by one of ordinary skill in the art that USB host transceiver 118, the local unit controller 120, the non-USB transceiver 122, the non-USB transceiver 124, the remote unit controller 126 and the USB device transceiver 128 may each be a control circuit implemented as one or combinations of the following: programmable circuit, integrated circuit, memory and I/O circuits, an application specific integrated circuit, microcontroller, complex programmable logic device, field programmable gate arrays, other programmable circuits, or the like.

In addition, the non-USB communications channel 106 may be any type of non-USB communications channel, such as a fiber optics communication channel, wire-based category 5 (“CAT5”) or category 6 (“CAT6”) communications channel or wireless communications channel. In addition, various types of communications mechanisms may be used. Exemplary communication mechanisms include Ethernet, Token-Ring™, 802.11-type wireless data transmission, or other wire-based or wireless data communication mechanisms as will be apparent to one of ordinary skill in the art.

Moreover, if a wireless non-USB communications channel 106 is utilized, the drivers of the non-USB transceivers 124 and 126 may be wireless transmitters. The transmitters for wireless and wire-based communications channels may be amplitude modulated or frequency modulated. Further, if the non-USB communications channel 106 is a fiber optic communications channel, the drivers may be fiber optic transmitters such as light emitting diodes (“LEDs”) or laser diodes (“LDs”) or the like. In addition, the fiber optic transmitter may be intensity modulated.

In one implementation, the remote unit controller 126 preferably keeps the USB communication channel 112c reset when the flash media device 110 is not connected to the remote unit 104. The remote unit 104 notifies the local unit 102 when the remote unit 104 detects the presence of the flash media device 110. In response, the local unit 102 simulates a hot plug of a mass storage device on the USB communication channel 112a and emulates a mass storage device to the USB host 108. The simulated hot plug causes the USB host 108 to note the presence of the mass storage device and to start enumerating the device. The local unit 102 answers requests from the USB host 108 by providing information relating to USB communication parameters, such as the size of USB packets. The mass storage device that is emulated to the USB host 108 by the local unit 102 may have different properties than the flash media device 110. For example, the size of the USB packets may be different between the local unit 102 and the actual flash media device 110. In addition, one or more of the following properties may be different between the emulated mass storage device and the flash media device 110: bcdUSB, bMaxPacketSize0, idVendor, idProduct, bcdDevice, iManufacturer, iProduct, iSerialNumber, bNumConfigurations, wTotalLength, bNuminterfaces, bConfigurationValue, iconfiguration, bmAttributes, and MaxPower, all of which are discussed in the Mass Storage Specification incorporated by reference herein. Preferably, however, the emulated mass storage device has the same size parameters as the flash media device 110.

Following enumeration of the emulated mass storage device, the USB host 108 will begin sending CBW data to the local unit 104. From this point until data transmission is complete, the remote unit 104 may act as a slave to the local unit 102. The local unit 102 will convert the CBW data to SCSI data and send the converted data to the remote unit 104 via the non-USB communications channel 106. The data sent over the non-USB communications channel 106 may be further converted or altered prior to transmission. For example, a proprietary data protocol may be used. Depending on the specific command generated by the USB host 108, data may be transferred in one direction or the other between the USB host 108 and the flash media device 110. Following the transfer of all data, the flash media device 110 will send a CSW to the remote unit 104 reporting the status of the data transfer execution. The remote unit 104 will then convert the CSW data to SCSI data and send the converted data to the local unit 102 via the non-USB communications channel 106. The data sent over the non-USB communications channel 106 may be further converted or altered prior to transmission.

Prior to generating the CSW and sending it to the remote unit 104 via the USB communication channel 112c, the flash media device 110 will return USB raw data packets to the remote unit 104. The remote unit 104 will send the USB raw data packets to the local unit 102. The local unit 102 will receive and store all of the USB raw data packets until the converted CSW data is received. While storing the USB raw data packets, the local unit 102 will send the USB host 108 a “not acknowledge” (NAK) response. Upon receipt of the NAK response, the host will retry the original message. Upon receipt of the converted CSW data, the local unit 102 will send all of the stored USB raw data packets, along with the restored CSW, to the USB host 108.

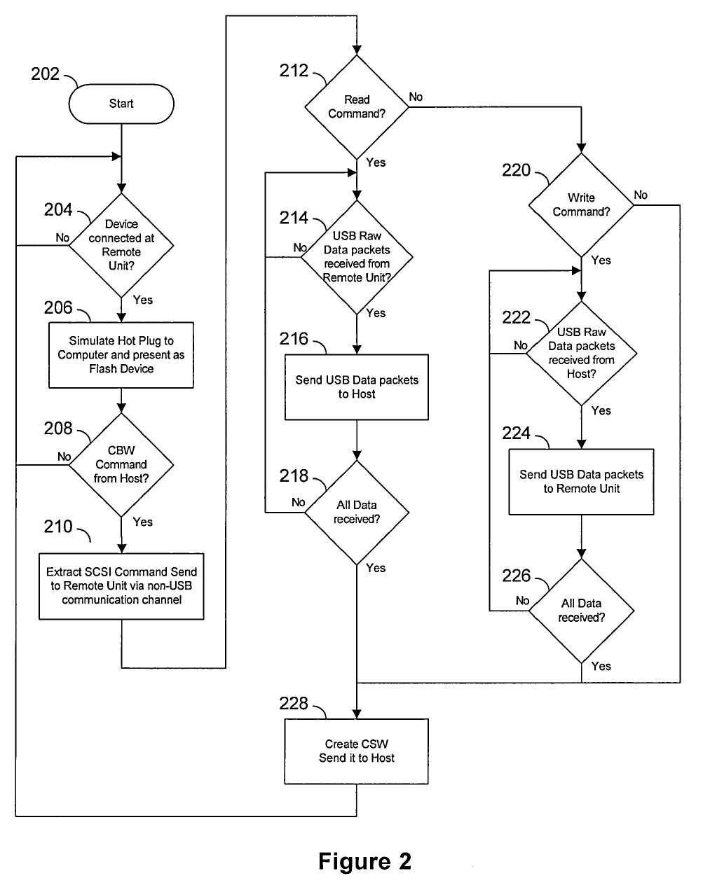

Turning next to FIG. 2 a flow chart illustrating another implementation of the functionality of the local unit 102 is provided. Flow begins at start block 202, from which flow progresses to decision block 204. At decision block 204, a determination is made whether a flash media device is connected to the remote unit. A negative determination at decision block 204 causes progression to loop back to decision block 204.

A positive determination at decision block 204 causes progression to process block 206. At process block 206, a hot plug is simulated to the host computer and a mass storage device is emulated to the host computer. Flow then continues to decision block 208 wherein a determination is made whether CBW data has been received from the host. A negative determination at decision block 208 causes progression to loop back to decision block 204. A positive determination at decision block 208 causes flow to progress to process block 210.

At process block 210 the received CBW data is converted to SCSI data and the converted data is sent to the remote unit by the non-USB communication channel. Flow then progresses to decision block 212 wherein a determination is made whether the received CBW data contains a read command. A positive determination at decision block 212 causes progression to the decision block 214, wherein a determination is made whether USB raw data packets have been received from the remote unit. A negative determination at decision block 214 causes progression to loop back to decision block 214. A positive determination at decision block 214 causes progression to process block 216 wherein USB data packets are sent to the USB host. Flow then continues to decision block 218 wherein a determination is made whether all USB data packets have been received. A negative determination at decision block 218 causes progression to loop back to decision block 214. A positive determination at decision block 218 causes progression to process block 228 wherein the CSW is created and sent to the USB host. Progression then flows back to decision block 204.

A negative determination at decision block 212 causes progression to decision block 220, wherein a determination is made whether the received CBW data contains write command. A negative determination at decision block 220 causes progression to process block 228. A positive determination at decision block 220 causes progression to decision block 222, wherein a determination is made whether raw data packets have been received from the host. A negative determination at decision block 222 causes flow to loop back to decision block 222. A positive determination at decision block 222 causes progression to process block 224 wherein USB raw data packets are sent to the remote unit. Flow then continues to decision block 226 wherein a determination is made whether all USB raw data packets have been received. A negative determination at decision block 226 causes progress to flow back to decision block 222. A positive determination at decision block 226 causes flow to continue process block 228.

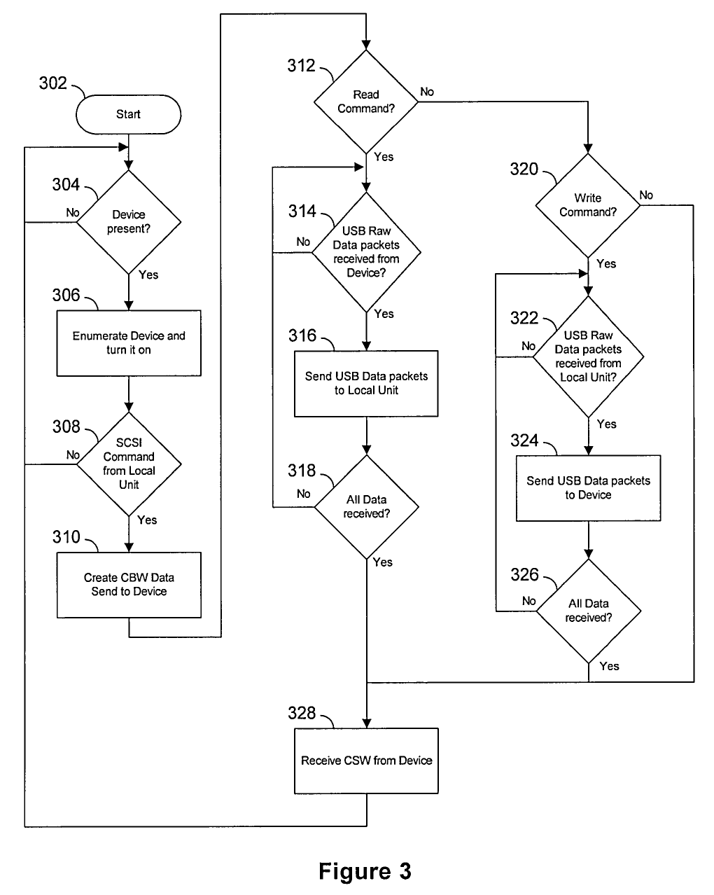

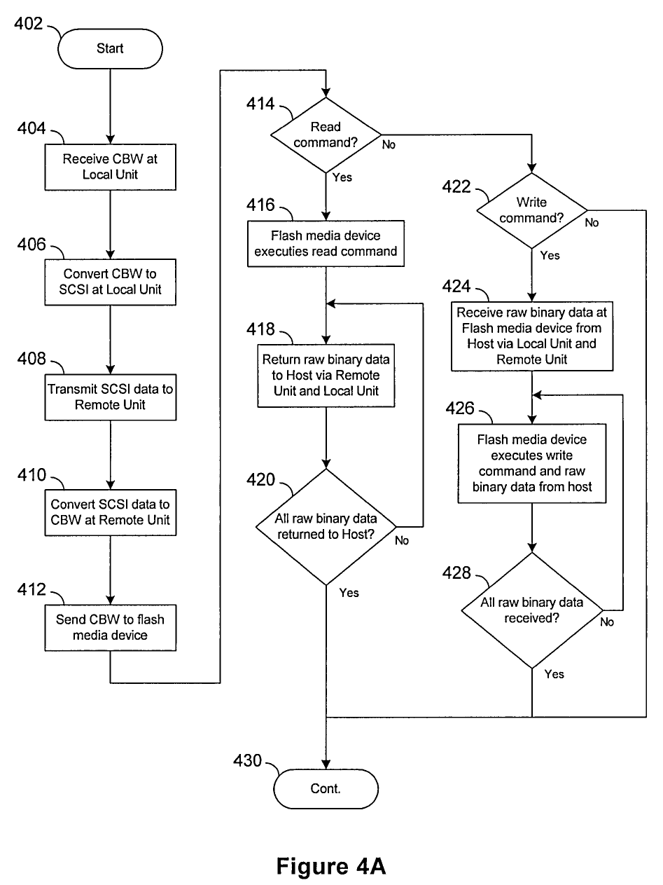

Turning next to FIG. 3, a flow chart illustrating one implementation of the functionality of the remote unit 104 is provided. Flow begins at start block 302 after which progression is made to decision block 304, wherein a determination is made whether a flash media device is present. A negative determination at decision block 304 causes progression to loop back to decision block 304. A positive determination at decision block 304 causes progression to continue to process block 306, wherein the flash device is enumerated and turned on. Flow then continues to decision block 308 wherein a determination is made whether SCSI data has been received from the local unit. A negative determination at decision block 308 causes progression to look back to decision block 304. A positive determination at decision block 308 causes progression to continue to process decision block 310, wherein SCSI data is converted to CBW data and sent to the flash media device. Flow then continues to decision block 312 wherein a determination is made whether the CBW data contains a read command.

A positive determination at decision block 312 causes progression to decision block 314, wherein a determination is made whether USB raw data packets have been received from the flash media device. A negative determination at decision block 314 causes progression to loop back to decision block 314. A positive determination at decision block 314 causes progression to process block 316, wherein USB data packets are sent to the local unit. Flow then continues to decision block 318 wherein a determination is made whether all USB data packets have been received. A negative determination at decision block 318 causes progression to loop back to decision block 314. A positive determination at decision block 318 causes progression to flow to process block 328, wherein CSW data is received from the flash media device. Progression then flows back decision block 304.

A negative determination at decision block 312 causes progression to decision block 320 wherein a determination is made whether the CBW data contains a write command. A negative determination at decision block 320 causes progression to process block 328. A positive determination of decision block 320 causes progression to decision block 322 wherein a determination is made whether USB raw data packets have been received from the local unit. A negative determination at decision block 322 causes flow to loop back to decision block 322. A positive determination at decision block 322 causes progression to process block 324, wherein USB raw data packets are sent to the flash media device. Flow then continues to decision block 326 where a determination is made whether all USB data packets have been received. A negative determination at decision block 326 causes progression to loop back to decision block 322. Positive determination at decision block 326 causes flow to continue to process block 328.

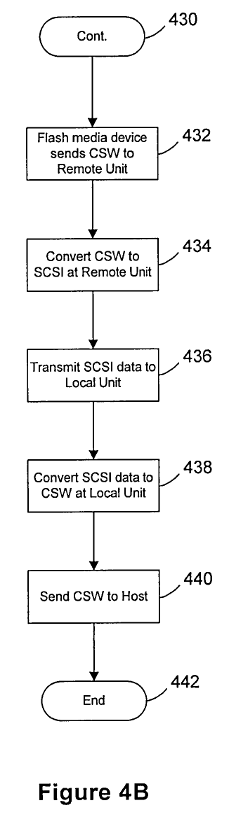

Turning next to FIGS. 4A-B, the general data flow for a flash media extender, such as the flash media extender of FIG. 1, is provided. Flow begins at start block 402 and progresses to process block 404. At process block 404, CBW data is received at the local unit. Flow continues to process block 406 wherein the CBW data is converted to SCSI data at the local unit. Flow then progresses to process block 408 wherein the converted SCSI data is sent to the remote unit. Progression then continues to process block 410 wherein SCSI data is converted to CBW data at the remote unit. Flow continues to process block 412 wherein the CBW data is sent to the flash media device. Flow then progresses to decision block 414 wherein a determination is made whether the CBW data contains a read command. A positive determination at decision block 414 causes progression to process block 416, wherein the flash media device executes a read command. Flow then continues to process block 418 wherein the flash media device returns raw binary data to the host via the remote unit and the local unit. Progression then flows to decision block 420 wherein a determination is made whether all raw binary data has been returned to the host. A negative determination at decision block 420 causes progression to flow back to process block 418 and a positive determination at decision block 420 causes progression to continuation block 430.

A negative determination at decision block 414 causes progression to decision block 422, wherein a determination is made whether the CBW data sent to the flash media device contain a write command. A negative determination at decision block 422 causes progression to continuation block 430. A positive determination in decision block 422 causes progression to process to block 424, wherein raw binary data is received at the flash media device from the host via the local unit and the remote unit. Progression then continues to process block 426 wherein the flash media device executes the write command using the raw binary data received from the host. Progression then continues to decision block 428 wherein a determination is made whether all binary data has been received. A negative determination at decision block 428 causes progression to flow back to process block 426 and a positive determination at decision block 428 causes progression to continuation block 430.

Progression continues from continuation block 430 to process block 432, wherein the flash media device sends CSW data to the remote unit. Progression then flows to process block 434 wherein the CSW data is converted to SCSI data at the remote unit. Flow then continues to process block 436 wherein the SCSI data is sent to the local unit. Flow then progresses to process block 438 wherein the received SCSI data is converted to CSW data at the local unit. Progression then continues to process block 440 wherein the CSW data is sent to the host, after which flow progresses to determination block 442.

While the present invention has been described in association with several exemplary embodiments, the described embodiments are to be considered in all respects as illustrative and not restrictive. Such other features, aspects, variations, modifications, and substitution of equivalents may be made without departing from the spirit and scope of this invention which is intended to be limited solely by the scope of the following claims. Also, it will be appreciated that features and parts illustrated in one embodiment may be used, or may be applicable, in the same or in a similar way in other embodiments.

What is claimed is:

1. A flash media extender comprising:
a local unit operably connectable to an external USB host and an external non-USB communications channel, the local unit being configured to simulate a hot plug and emulate a mass storage device to the USB host; and
a remote unit operably connectable to an external flash media device and the non-USB communications channel, the non-USB communications channel and the local unit being external to the remote unit, the remote unit being configured to enumerate the flash media device;
wherein the local unit is configured to receive command block wrapper data from the USB host, convert the command block wrapper data to SCSI data, and send the converted data to the remote unit via the non-USB communications channel; and
wherein the remote unit is configured to receive the converted data sent by the local unit via the non-USB communications channel, convert the received data to command block wrapper data, and send the command block wrapper data to the flash media device.

2. The flash media extender of claim 1 wherein the mass storage device emulated to the USB host has different properties than the flash media device.

3. The flash media extender of claim 1 wherein the remote unit is further configured to receive USB raw data packets from the flash media device and send the USB raw data packets to the local unit via the non-USB communications channel.

4. The flash media extender of claim 1 wherein the remote unit is further configured to receive command status wrapper data from the flash media device, convert the command status wrapper data to SCSI data, and send the converted data to the local unit via the non-USB communications channel.

5. The flash media extender of claim 4 wherein the local unit is further configured to receive the converted data sent by the remote unit via the non-USB communications channel, convert the received data to command status wrapper data, and send the command status wrapper data to the USB host.

6. The flash media extender of claim 1 wherein the local unit is further configured to convert the SCSI data to non-SCSI data prior to sending the data to the remote unit via the non-USB communications channel.

7. The flash media extender of claim 1 wherein the local unit is further configured to determine if the command block wrapper data represents a read command or a write command.

8. The flash media extender of claim 7 wherein upon determination of a read command, the remote unit is further configured to send USB raw data packets to the local unit via the non-USB communications channel and the local unit is further configured to receive the USB raw data packets from the remote unit via the non-USB communications channel and send the USB raw data packets to the USB host.

9. The flash media extender of claim 7 wherein upon determination of a write command, the local unit is further configured to send USB raw data packets to the remote unit via the non-USB communications channel and the remote unit is further configured to receive the USB raw data packets from the local unit via the non-USB communications channel and send the USB raw data packets to the flash media device.

10. The flash media extender of claim 1 wherein the non-USB communications channel comprises four twisted pairs of wires.

11. The flash media extender of claim 1 further comprising:
a flash media extender according to claim 1; and
a non-USB communications channel;
wherein the local unit and the remote unit are communicably coupled via the non-USB communications channel.

12. A flash media extender comprising:
a local unit operably connectable to an external USB host and an external non-USB communications channel, the local unit comprising:
a local unit controller configured to simulate a hot plug and emulate a mass storage device to the USB host and to control data flow;
a USB host transceiver configured to convert command block wrapper data to SCSI data and to convert SCSI data to command block wrapper data; and
a non-USB transceiver configured to send the converted data to a remote unit via a non-USB communications channel.
a remote unit separately housed from the local unit and the non-USB communications channel and operably connectable to an external flash media device and the non-USB communications channel, the remote unit comprising:
a remote unit controller configured to enumerate the flash media device and to control data flow;
a non-USB transceiver configured to receive the converted data sent by the local unit via the non-USB communications channel;
a USB device transceiver configured to convert the received data to command block wrapper data.

13. The flash media extender of claim 12 wherein the mass storage device emulated to the USB host has different properties than the flash media device.

14. The flash media extender of claim 12 wherein at least one of the local unit controller or the remote unit controller comprises multiple controllers.

15. A method for extending communication between a flash media device and a USB host comprising:
simulating a hot plug and emulating a mass storage device to a USB host;
receiving at a local unit command block wrapper data;
converting the received command block wrapper data to SCSI data;
sending the converted data to a remote unit via a non-USB communications channel that is separately housed from the local unit and the remote unit;
receiving at the remote unit the converted data via the non-USB communications channel;
converting the data received via the non-USB communications channel to command block wrapper data; and
sending the command block wrapper data to a flash media device.

16. The method of claim 15 wherein the mass storage device emulated to the USB host and the flash media device have different properties.

17. The method of claim 15 further comprising receiving USB raw data packets from the flash media device at the remote unit and sending the USB raw data packets to the local unit via the non-USB communications channel.

18. The method of claim 15 further comprising receiving command status wrapper data from the flash media device at the remote unit, converting the command status wrapper data to SCSI data, and sending the converted data to the local unit via the non-USB communications channel.

19. The method of claim 18 further comprising receiving at the local unit the converted data sent by the remote unit via the non-USB communications channel, converting the received data to command status wrapper data, and sending the command status wrapper data to the USB host.

20. The method of claim 15 further comprising converting the SCSI data to non-SCSI data prior to sending the converted data to the remote unit via the non-USB communications channel.

21. The method of claim 15 further comprising determining if the command block wrapper data represents a read command or a write command.

22. The method of claim 21 wherein upon determination of a read command the method further comprises sending USB raw data packets from the remote unit to the local unit via the non-USB communications channel, receiving the USB raw data packets at the local unit via the non-USB communications channel, and sending the USB raw data packets to the USB host.

23. The method of claim 21 wherein upon determination of a write command the method further comprises sending USB raw data packets to the remote unit via the non-USB communications channel, receiving the USB raw data packets at the remote unit via the non-USB communications channel, and sending the USB raw data packets to the flash media device.
